(19) United States
(12) Patent Application Publication
(10) Pub. No.: US 2007/0043627 A1
(43) Pub. Date: Feb. 22, 2007

(54) Interface and method of connecting sellers with consumers seeking home furnishings

(76) Inventor: Denise Harrison Cooperman, Cherry Hill, NJ (US)

Correspondence Address: FOX ROTHSCHILD LLP;PRINCETON PIKE CORPORATE CENTER, 997 LENOX DRIVE, BUILDING #3, LAWRENCEVILLE, NJ, 08648, US

(21) Appl. No.: 11/273,500

(22) Filed: Nov. 14, 2005

Related U.S. Application Data
(60) Provisional application No. 60/709,365, filed on Aug. 18, 2005.

(51) Int. Cl. G06Q 30/00

(52) U.S. Cl. 705/26

(57) ABSTRACT

A system and related method are described for managing business information in the home furnishings industry. The method provides a forum for subscribing consumers, retailers, and/or distributors to reduce costs and increase efficiency by directly exchanging information with one another. A consumer may query, for example, a specific item by inputting search criteria into the fields of a search engine. In response, the search engine directly provides information on retailers and/or distributors that sell the specific item, preferably in the consumer's area, to the consumer.

Priority is derived from U.S. Provisional Application Ser. No. 60,709,365, filed Aug. 18, 2005, which disclosure is herein incorporated by reference.

### FIELD OF THE INVENTION

This invention relates to a method of managing business information in the home furnishings industry. Consumers, retailers, and distributors, for example, are directly connected over an interface, such as a website. The invention further relates to a system for implementing the method of managing business information in the home furnishings industry.

### BACKGROUND OF THE INVENTION

Many problems exist in efficiently running each facet of a home decorative and furniture business today. There is no easy way for the consumer to customize a floor plan and then find matching furniture. Currently, if a consumer wants a customized floor plan they can go to an expensive consultant, find a do-it-yourself alternative or an internet website. However, consultants charge by the hour and fees can range between $50.00-$350.00 per hour plus percentages between 10%-30% that are added to the purchase price of the furniture. Do-it-yourself alternatives and websites are an option; however, no website currently exists where a consumer receives, for example, consultation, customized floor plans and recommendations on placement of furniture lightings and accessories.

Furthermore, there is no easy and cost-effective way for the retailer and/or distributor, for example, to advertise. Currently, researching specific products from a variety of vendors is very expensive and time consuming. Alternatively, failing to do the research can lead to other costs associated with high inventories or not enough inventory of popular items.

In addition, advertising and introducing new products from distributors is very time consuming and expensive. Most distributors attend various expensive and time consuming trade shows to advertise and introduce new products. With the expansion of the trade show market into Las Vegas, and possibly overseas, a license to all the trade shows can easily be cost prohibitive and a diffusion of importance.

Therefore, there is currently a need in the home decorative and furniture business to manage an efficient exchange of information for consumers, retailers and/or distributors. Managing the exchange of information between consumers, retailers and/or distributors on a single interface would be more cost-effective and efficient than the methods that currently exist.

### SUMMARY OF THE INVENTION

The present invention is directed to a method of managing business information in the home furnishings industry. The method provides subscription based services for consumers, retailers, and/or distributors, for example, on a single interface. Subscription based services described herein provide access to products and services specifically tailored to the specific needs of each group. Home decorative information may be directly exchanged between consumers, retailers and/or distributors on a single interface, such as for example, a website.

An embodiment of the method provides the consumer with one-stop researching for home decorative and furniture products, designs and services. Consumers have the ability, for example, to query for specific items based on search criteria to match a customized floor plan. The website provides recommendations on how to arrange furniture or what furniture to place in the customized floor plan produced by live interior designers. Furthermore, consumers, for example, have access to a database or databases of coupons such as, but not limited to, factory rebates, store discounts and credit card incentives posted by retailers and/or distributors.

The method described herein provides retailers, for example, a single forum to directly advertise home decorative and furnishing products, designs and services or coupons and sales. Statistics and data collected from executed queries for specific items will be available, in certain embodiments, to the retailers. The information will diminish the need for expensive research and travel to determine which products to carry from which vendors. Information obtained from the collected statistics and data will help streamline inventories and reduce costs. In further embodiments, retailers can directly advertise matching items and provide detailed store contact information on where to purchase the matching item in response to the query.

Finally, the method described herein will also provide distributors, for example, a single forum to directly advertise home decorative and furnishing products, designs and services or coupons and sales. Distributors will no longer be required to solely attend expensive, time consuming and expanding trade shows to advertise or introduce new products. Statistics and data collected from executed queries for specific items will be available, in certain embodiments, to the distributor. A subscription to the website will add the distributors to the cataloguing system. In further embodiments, distributors can directly advertise matching items in response to the query. In addition to displaying the retailers that sell the specific item, whether it be a collection or from a particular manufacturer, when a query is executed the distributor's name will also be displayed in association with the specific items made by the distributor.

In a further embodiment, the current invention is further directed to a system for managing business information in the home furnishing industry. A plurality of subscribing end-user clients are connected to a server via an internet or intranet connection. A subscribing end-user client can access stored home decorative information on the server provided by other subscribing end-user clients via an interface, such as for example, a website. The website comprises product resource tools, customized floor plans and furniture products, lighting and accessory recommendations and an arrangement of the recommended furniture products, lighting and accessories. The product resource tools further comprise a search engine and a database of coupons. A subscribing end-user client can query a specific item and price category by inputting search criteria into the fields of the search engine. In response, the search engine returns results that match the search criteria of the specific item. The search engine provides information on stores that carry the specific item the subscribing end-user client is looking for.

Another embodiment of the invention is further directed to a computer readable medium storing instructions for executing a method for managing business information in the home furnishings industry over an interface, such as for example, a website. The computer readable medium storing instructions executes instructions for generating a website; granting access to the website by subscribing consumers, retailers and/or distributors; storing home decorative and furniture product, design and service information submitted by the subscribing consumers, retailers and/or distributor; and granting direct access to the home decorative and furniture product, design and service information to the subscribing consumers, retailers and/or distributors.

### BRIEF DESCRIPTION OF THE FIGURES

FIG. 1 is a diagram of the system configuration.

FIG. 2 is screenshot of the website homepage.

FIG. 3 is a screenshot of the consumer home page.

FIG. 4 is a screenshot of the customized floor plan page connected to from the link in FIG. 3.

FIG. 5 is a screenshot of the search engine page.

FIG. 6 is a screenshot of the search results page.

FIG. 7 is a screenshot of the retailer home page.

FIG. 8 is a screenshot of the distributor home page.

### DETAILED DESCRIPTION OF THE INVENTION

Unless defined otherwise, all technical and scientific terms used herein have the same meaning as is commonly understood by one of skill in the art to which this invention belongs. All publications and patents referred to herein are incorporated by reference.

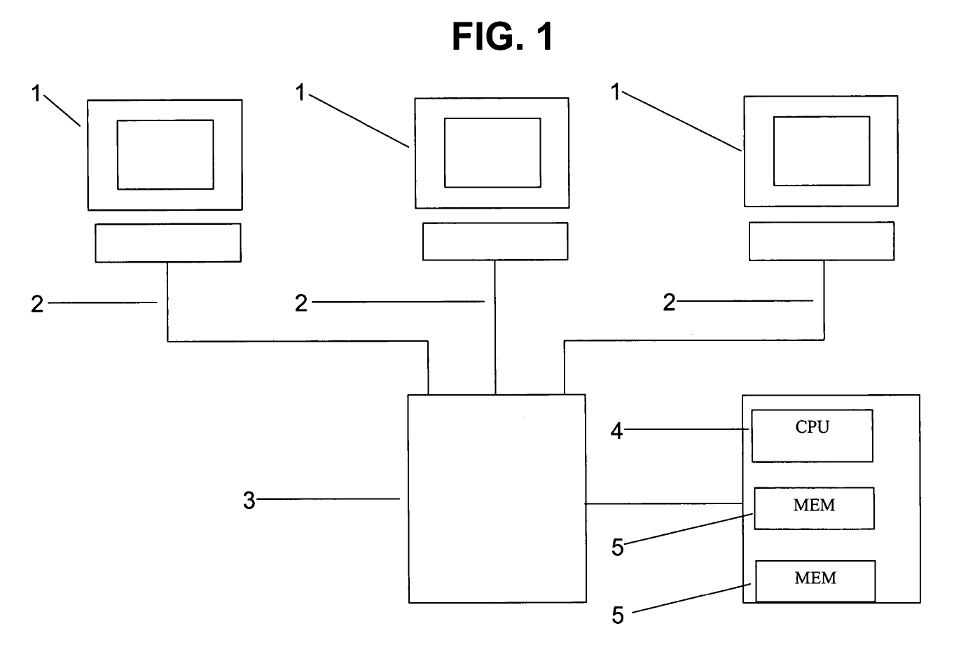

FIG. 1 illustrates an exemplary system implementing the invention and method of managing business information in the home furnishings industry. Business information as used herein is defined as for example, but not limited to inventory, pricing, advertisements, promotions, furniture recommendations, customized floor plans and compiled statistics. Moreover, utilization of the exemplary system allows home decorative and furniture service, design and product information to be directly accessed. Home decorative information as used herein is defined as for example, but not limited to price, color, dimensions and/or fabric type of curtains, rugs, paintings, and the like. Furniture service, design and product information as used herein is defined as, for example, but not limited to price, color, fabric type and/or dimensions of sofas, couches, chairs, shelving, lamps, tables and the like.

FIG. 1 shows a plurality of end-user clients 1 that are connected to a server 3 via an internet or intranet connection 2. The plurality of end-user clients are users from at least two sectors of the industry selected from the group consisting of consumers, retailers, and distributors. Consumers are herein defined to mean, for example, any individual or group looking to purchase a product, service or design, e.g., arrangement plan. Retailers are herein defined to mean, for example, any individual, group, designer, company, store or corporation selling a product, service or design to consumers. Distributors are herein defined to mean, for example, any manufacturer, importer or exporter that creates, builds, designs or originates a product, service or design to be distributed to retailers and/or consumers.

Inside server 3 is a computer processing unit (CPU) 4 and memory 5. The plurality of end-user clients 1 can gain access to server 3 by paying a subscription fee. The subscription fee can be assessed on any periodic basis, such as weekly, monthly, yearly, or on a one time basis. Memory 5 stores detailed information submitted by the plurality of end-user clients 1 that pay the subscription fee. Detailed information may be, for example, information on products, designs and services and detailed contact information of retailers and/or distributors submitted by subscribing plurality of end-user clients 1. CPU 4 executes instructions stored in memory 5 for generating a web page and granting access to the web page and detailed information by subscribing plurality of end-user clients 1. By utilizing the invention disclosed herein, managing the exchange of information between consumers, retailers and distributors is more efficient and cost-effective than methods that currently exist. As a result, a considerable amount of time and money is saved by advertising on a single forum where consumers, retailers and distributors alike can be reached.

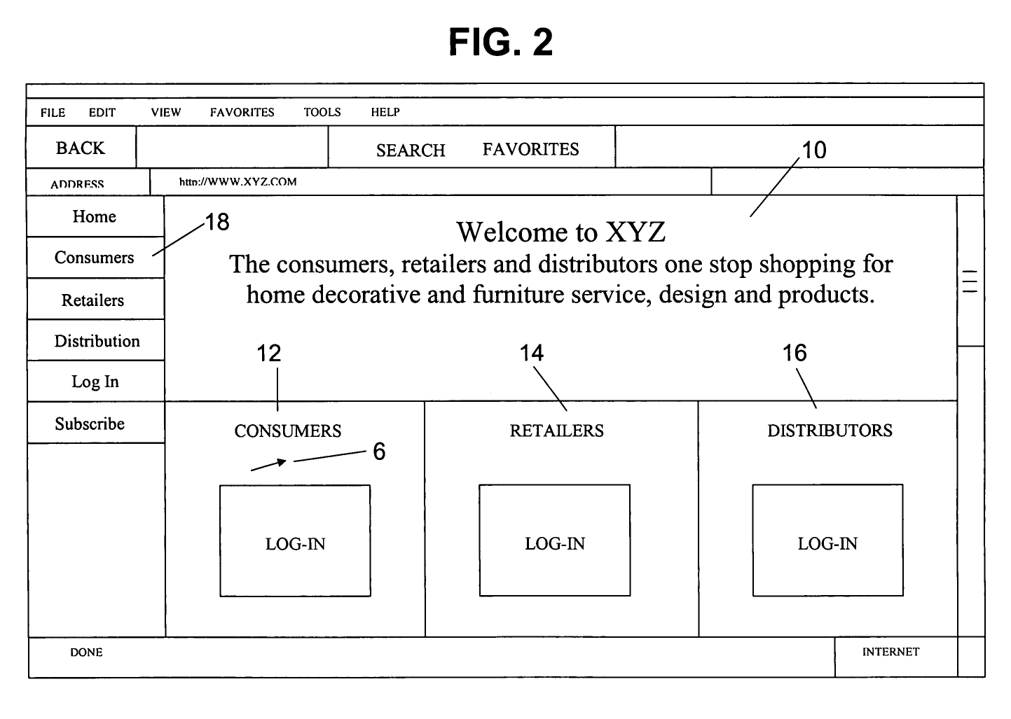

FIG. 2 illustrates an embodiment of an exemplary interface where the single forum is conducted. The interface, for example, is a website generated by CPU 4 that allows consumers, retailers, and/or distributors to directly exchange information with one another. In an exemplary embodiment, the website includes home page 10 with links 18 connecting to various sites and services such as, but not limited to, subscription management, consumers, retailers, distributors, log-in and home. Also on home page 10 are links to various log-ins depending on who the plurality of end-user clients 1 are, such as a consumer log-in 12, a retailer log-in 14 and a distributor log-in 16. The consumer may choose any of the links by clicking cursor 6 on the respective links 18, consumer log-in 12, retailer log-in 14 or distributor log-in 16.

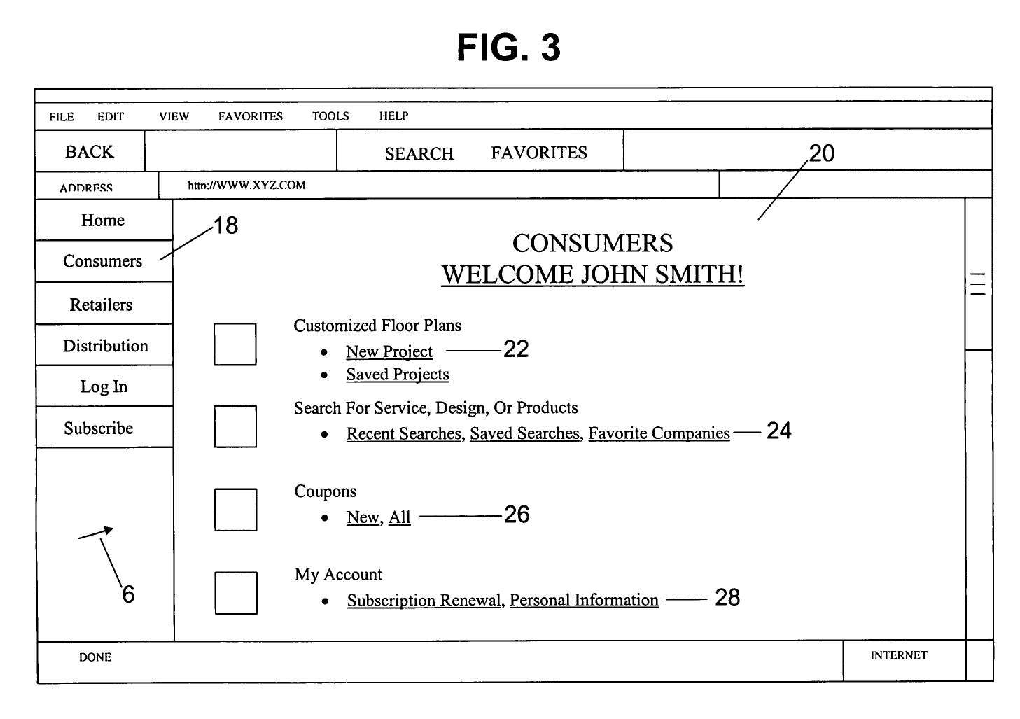

If one of the plurality of end-user clients 1 is a consumer, the consumer clicks on the consumer log-in 12 and is directed to a consumer home page 20 as shown in FIG. 3. Consumer home page 20 is a one-stop shopping and consulting website that allows the consumer to eliminate the need to hire an expensive interior designer and save enormous amounts of time spent on shopping and researching.

Consumer home page 20 includes product resource tools and customized floor plans. In an embodiment of the present invention, product resource tools are, for example, a search engine, a web site of coupons or a website for account management. Consumer home page 20 provides access to product resource tools via a link to search engine 24, a link to coupons 26 and a link to account management 28. The link to coupons 26 directs the consumer to a page that includes coupons, such as, but not limited to, factory rebates, store discounts and credit card incentives advertised by retailers and distributors. The link to account management 28 directs the consumer to a page to renew subscriptions and update personal contact information. In addition, a link for customized floor plans can be accessed by a link to customized floor plans 22.

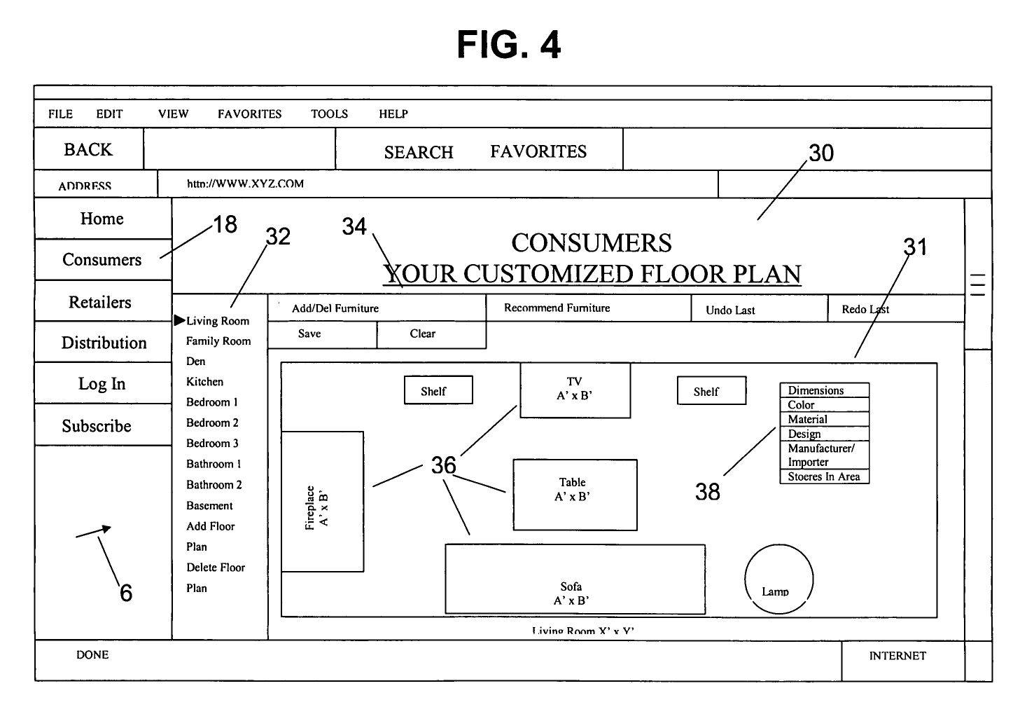

When the consumer clicks on the link to customized floor plans 22, the consumer is directed to a customized floor plan page 30 as shown in FIG. 4. In one embodiment of the present invention, customized floor plan page 30 includes, for example, links to saved customized floor plans 32 and a toolbar 34. Tool bar 34 includes buttons for various actions to customize a selected customized floor plan 31. Tool bar 34 may include buttons such as, but not limited to, adding and deleting furniture, recommending furniture, undo last, redo last, save and clear.

When the consumer clicks on a room listed in the links to the saved customized floor plans 32, the selected customized floor plan 31 appears on the customized floor plan page 30. Customized floor plan 31 is drawn to scale and includes a plurality of icons 36. Plurality of icons 36 represent various furniture pieces arranged in customized floor plan 31. When the consumer places the cursor 6 over any one of the plurality of icons 36 a pop-up window 38 appears. Pop-up window 38 includes information on the selected icon 36, such as dimensions, color, material, design, distributor and retailers in the consumer's area selling the furniture piece represented by the chosen one of the plurality of icons 36.

If the consumer is not sure what furniture to add or how to arrange the plurality of icons 36 on customized floor plan 31, the consumer may click on the recommend furniture button on toolbar 34. Clicking on the recommend furniture button on toolbar 34 provides recommendations on what furniture products, lighting or accessories to add. In addition, the recommend furniture button on toolbar 34 provides recommendations on how to arrange the recommended furniture products, lighting or accessories based on the dimensions of the recommended furniture products, lighting or accessories and customized floor plan 31. Moreover, if the consumer has chosen the furniture products, lighting or accessories, but is not sure how to arrange them, clicking on the recommend furniture button on toolbar 34 will also recommend how to arrange the chosen furniture products, lighting or accessories based on the dimensions of the furniture products, lighting or accessories and customized floor plan 31.

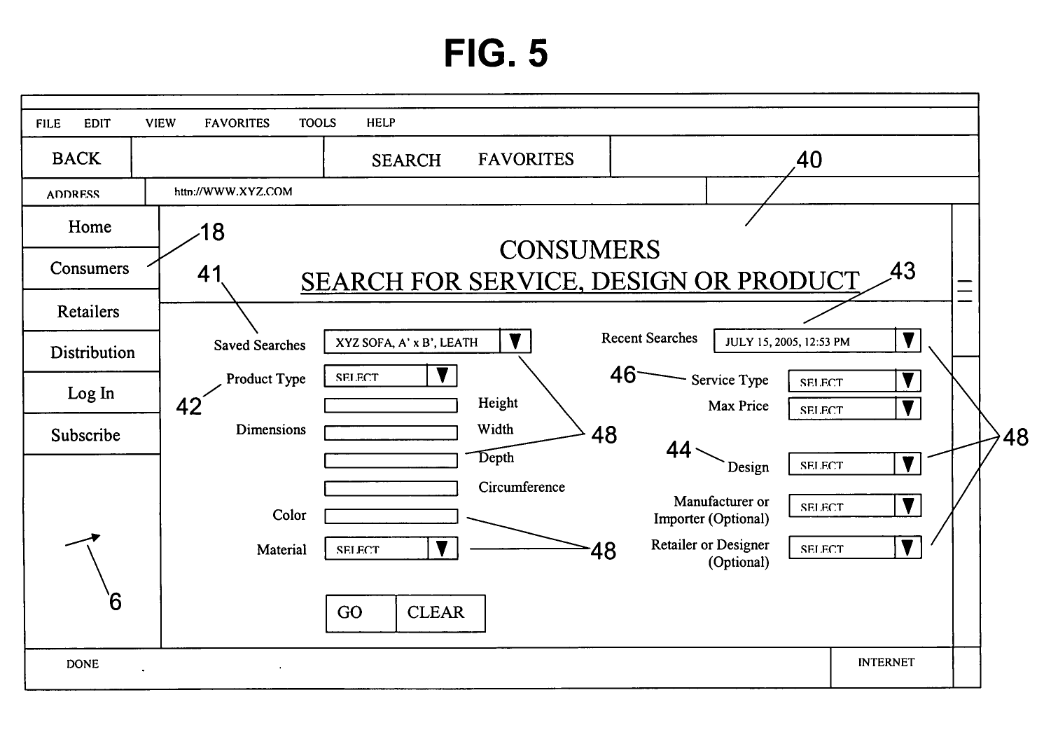

Referring back to FIG. 3, the consumer may also directly look for specific furniture products, designs or services by clicking on the link to search engine 24. Clicking on the link to search engine 24 directs the consumer to a search engine page 40 as shown in FIG. 5. The consumer may also enter the search engine page 40 by clicking on the add furniture button on tool bar 34 shown in FIG. 4.

Search engine page 40 allows the consumer to query for specific items by inputting search criteria. Search engine page 40 allows the consumer to query for specific items, for example a product 42, a design 44 or a service 46. Search engine page 40 also allows retailers and distributors to directly advertise in response to the inputted search criteria. Direct advertisement as used herein means displaying an advertisement directly to a person looking for a specific item. In contrast, normal or general advertisement displays products and services to the public in an unsolicited attempt to entice the public to purchase the advertised product or service. The search engine page 40 allows the consumer to quickly and efficiently find specific items they are looking for without having to waste endless hours shopping and researching what stores carry the specific item they are looking for.

Each of the queries for specific items by product 42, design 44 or service 46 include a plurality of fields 48. Plurality of fields 48 may be, for example, either a drop down window or a blank field for receiving search criteria. The plurality of fields 48 are populated by selecting from the drop down window or inputting in the blank fields search criteria about the specific item. The inputted search criteria depends on whether the query is for a product 42, a design 44 or a service 46. If the query is for a product 42, the inputted search criteria includes information such as, but not limited to, product type, dimensions, price category (low end, medium end or high end), type of material and color. If the query is for a design 44, the inputted search criteria includes information such as, but not limited to, price category (low end, medium end or high end), design, distributor or retailer. Finally, if the query is for a service 46, the inputted search criteria includes information such as, but not limited to, the type of service and price category (low end, medium end or high end). Moreover, the consumer may re-run queries, for example, by clicking on a link to saved searches 41 or recent searches 43. Selecting saved searches 41 or recent searches 43 automatically populates the respective plurality of fields 48.

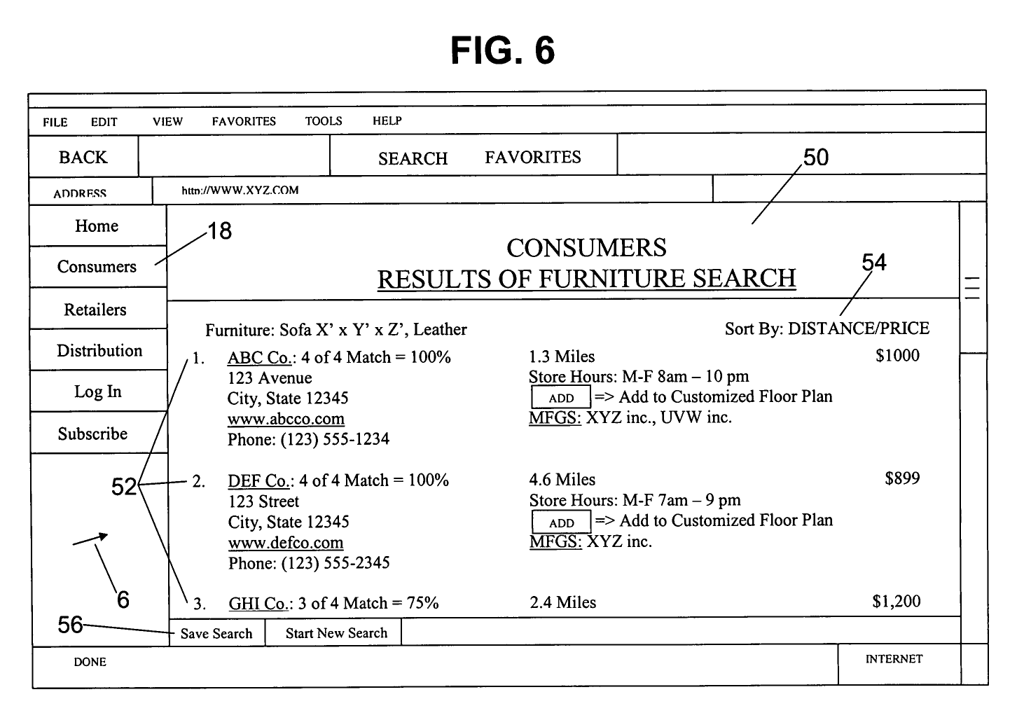

Once the search criteria is inputted for the product 42, design 44 or service 46, clicking “go” runs the query and returns a search results page 50 as shown in FIG. 6. Search results page 50 returns a plurality of results 52 in response to the query. Plurality of results 52 is sorted in descending order of statistical match of each field of the inputted search criteria. Each of the plurality of results 52 includes detailed store contact information including, for example, an address, a website link, a phone number, store hours, distance from the consumer's location and directions. Each of the plurality of results 52 also includes information on the price and the names of distributors of the specific item that the consumer is looking. In alternative embodiments not shown in FIG. 6, search results page 50 also includes links to photos of each of the plurality of results 52 that are uploaded by either the retailer or distributor.

Search results page 50 also contains sort buttons 54 and action buttons 56. Sort buttons 54 allow the consumer to re-arrange the plurality of results 52 by a different criteria such as distance from the consumer's location and price. Action buttons 54 allow the consumer to initiate certain actions such as saving the current query or starting a new query.

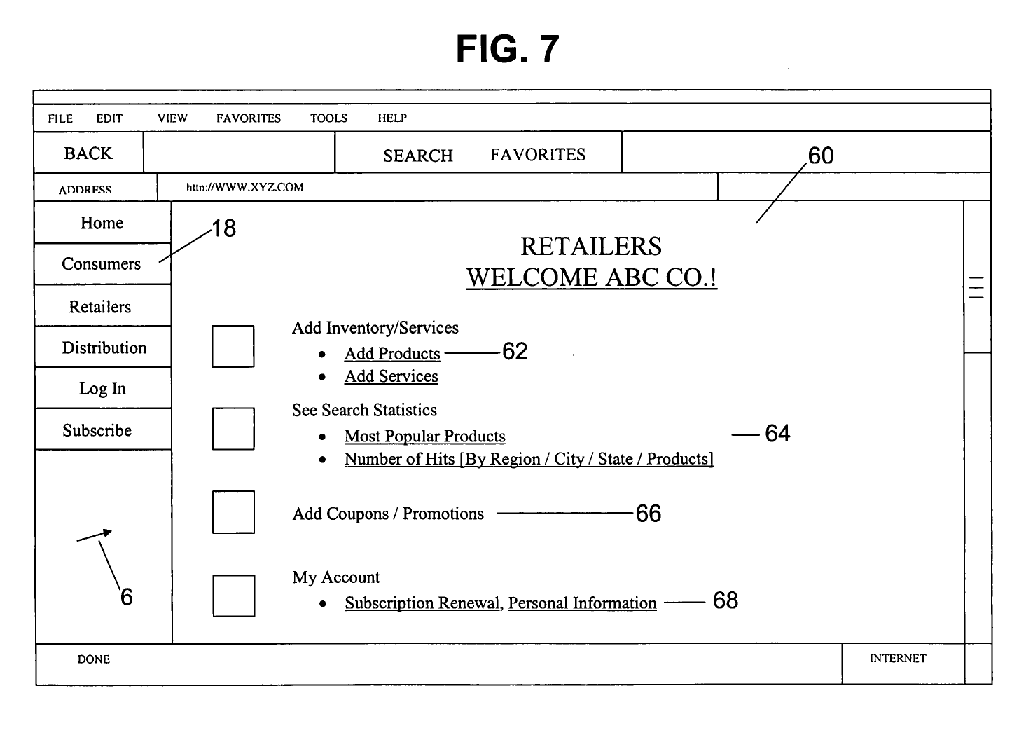

Referring back to FIG. 2, if the end-user client is a retailer, the retailer clicks on the retailer log-in 14 and is directed to a retailer home page 60 as shown in FIG. 7. Retailer home page 60 is a cost effective forum for retailers to directly advertise to consumers. Retailers save money by reducing costs associated with compiling market research and eliminating the need to attend expensive trade shows. Subscribing retailers are added to a cataloging system used by the search engine page 40.

Retailer home page 60 include, for example, a link to add inventory and services 62, a link to statistics 64, a link to add coupons and promotions 66 and a link to account management 68. Retailers can click on the link to add inventory and services 62 to constantly update inventory and services to increase the probability of matching specific items in response to queries run on search engine page 40. Retailer home page 60 further provides retailers access to statistics compiled by the website via link to statistics 64. Compiled statistics include, but are not limited to, most searched for items, number of matches to the retailer or information on queries by originating region, city or state. Analyzing the compiled statistics by methods such as comparative analysis, for example, will help retailers streamline inventory and reduce costs by comparative analysis. In addition, retailers can add coupons and promotions via the link to coupons and promotions 66. Finally, retailers can manage their subscription and detailed contact information via the link to account management 68.

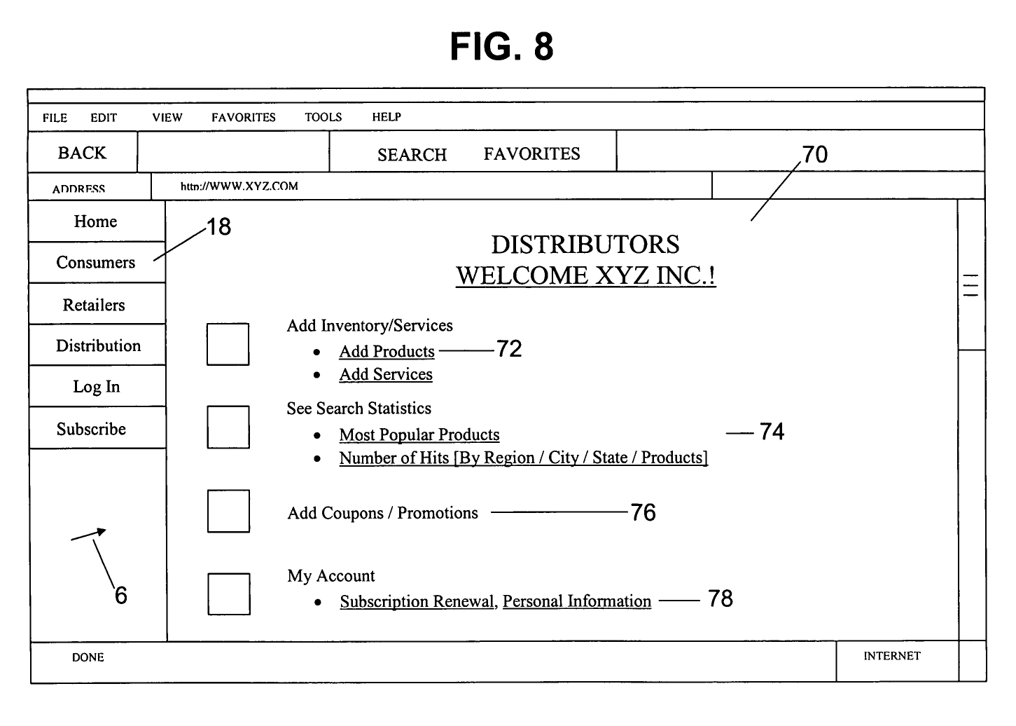

Referring back to FIG. 2, if the end-user client is a distributor, the distributor clicks on the distributors log-in 16 and is directed to a distributor home page 70 as shown in FIG. 8. Distributor home page 70 is a cost effective forum for distributors to directly advertise to consumers and retailers. Distributors save money by eliminating the need to attend expensive trade shows and costs associated with attending the expensive trade shows. In addition, subscribing distributors are added to a cataloging system that is used by the search engine page 40.

Distributor home page 70 includes, for example, a link to add inventory and services 72, a link to statistics 74, a link to add coupons and promotions 76 and a link to account management 78. Distributors can click on the link to add inventory and services 72 to constantly update inventory and services to match specific items consumers are looking for. Distributor home page 70 provides distributors access to statistics compiled by the website via link to statistics 74. Compiled statistics include, but are not limited to, most searched for items, number matches to the retailer or designer or searches by originating region, city or state. Analyzing the compiled statistics by methods such as comparative analysis, for example, will help distributors streamline their inventory and reduce costs. In addition, distributors can add coupons and promotions via the link to coupons and promotions 76. Finally, distributors can manage their subscription and detailed contact information via the link to account management 78.

All publications and patents referred to herein are incorporated by reference. Various modifications and variations of the described subject matter will be apparent to those skilled in the art without departing from the scope and spirit of the invention. Although the invention has been described in connection with specific embodiments, it should be understood that the invention as claimed should not be unduly limited to these embodiments. Indeed, various modifications for carrying out the invention are obvious to those skilled in the art and are intended to be within the scope of the following claims.

What is claimed is:

1. A method of managing business information in the home furnishings industry to enhance commerce comprising:
providing a subscription based service to parties from at least two sectors of the industry selected from the group consisting of consumers, retailers and distributors on an interface; wherein the subscription based service comprises electronic access to business information from each sector to enable efficient transactions in the industry thereby enhancing commerce.

2. The method of claim 1, wherein the subscription based service to consumers further comprises providing a product resource tool and a customized floor plan.

3. The method of claim 2, wherein the interface further comprises a search engine for entering search criteria in a query.

4. The method of claim 3, wherein the search engine provides business information that matches the search criteria of the query.

5. The method of claim 1, wherein the subscription based service further comprises a forum for directly advertising.

6. The method of claim 2, wherein the subscription based service further comprises a forum for directly advertising in response to the query matching the search criteria.

7. A system for managing business information in the home furnishing industry comprising:
a server that stores home decorative information provided by subscribers from at least two sectors of the industry selected from the group consisting of consumers, retailers and distributors;
an internet or intranet connection connecting a plurality of subscribing end-user clients to the server; and
an interface that allows the plurality of subscribing end-user clients to directly access the home decorative and furniture service, design and product information stored on the server.

8. The system of claim 7, wherein the home decorative information provided by subscribers further comprises detailed information.

9. The system of claim 7, wherein the interface is a website.

10. The system of claim 9, wherein the website comprises a search engine; wherein the search engine comprises fields for the plurality of subscribing end-user clients to enter search criteria in a query and the search engine, in response, returns detailed information matching the search criteria in the query.

11. The system of claim 7, wherein the interface further comprises a customized floor plan made to scale accessible by the plurality of subscribing end-user clients.

12. The system of claim 11, wherein the interface further comprises furniture product, lighting and accessory recommendations for the customized floor plan.

13. The system of claim 11, wherein the interface further comprises recommendations on the arrangement of furniture products, lightings and accessories in the customized floor plan.

14. The system of claim 12, wherein the interface further comprises information on stores in the plurality of subscribing end-user clients' area that sell the furniture product, lighting and accessory recommendations.

15. A computer readable medium storing instructions for executing a method for managing business information in the home furnishing industry over a website comprising:
generating a website;
granting access to the website to subscribing consumers, retailers and/or distributors;
storing home decorative and furniture product, design and service information submitted by the subscribing consumers, retailers and/or distributors; and
granting direct access to the home decorative and furniture product, design and service information to the subscribing consumers, retailers and/or distributors.

16. The computer readable medium storing instructions for executing a method for managing business information of claim 15 further comprising generating a search engine in the website.

17. The computer readable medium storing instructions for executing a method for managing business information of claim 16, further comprising generating fields for receiving search criteria for a specific item in the search engine and the search engine, in response, returns detailed contact information about stores selling the specific item.

18. The computer readable medium storing instructions for executing a method for managing business information of claim 15, further comprising storing a customized floor plan made to scale on the website.

19. The computer readable medium storing instructions for executing a method for managing business information of claim 18, further comprising providing recommendations on furniture products, lightings and accessories and arrangement of the recommended furniture products, lighting and accessories in the customized floor plan on the website.

20. The computer readable medium storing instructions for executing a method for managing business information of claim 19, further comprising displaying on the website detailed information on stores that sell the recommended furniture products, lightings and accessories.
